(19) United States
(12) Patent Application Publication
(10) Pub. No.: US 2025/0191080 A1
(43) Pub. Date: Jun. 12, 2025

(54) METHOD FOR SOCIAL NETWORKING BASED ON VIRTUAL IMAGE, SYSTEM, STORAGE MEDIUM, AND TERMINAL DEVICE

(71) Applicant: TENCENT TECHNOLOGY (SHENZHEN) COMPANY LIMITED, Shenzhen (CN)

(72) Inventors: Yaohua YUE, Shenzhen (CN); Kai KANG, Shenzhen (CN); Wenbo XIONG, Shenzhen (CN); Chenguang Yang, Shenzhen (CN); Song HE, Shenzhen (CN); Qiming ZHU, Shenzhen (CN)

(21) Appl. No.: 19/059,444

(22) Filed: Feb. 21, 2025

Related U.S. Application Data
(63) Continuation of application No. PCT/CN2023/133170, filed on Nov. 22, 2023.

(30) Foreign Application Priority Data
Jan. 20, 2023 (CN) 202310125248.X

(51) Int. Cl. G06Q 50/00; G06T 15/00; H04L 51/04

(52) U.S. Cl. CPC G06Q 50/01; G06T 15/00; H04L 51/04

(57) ABSTRACT

Embodiments of the present disclosure disclose a method for social networking based on a virtual image, a system, a storage medium, and a terminal device, and is applied to the field of information processing technologies. A social application interface displayed by a social application system includes an object screening control and a virtual image of each social object. In this way, a first social object related to an online state of a current social user is determined through an operation performed on the object screening control, the object screening control is collapsed, and a virtual image of the first target social object is displayed.

### CROSS-REFERENCES TO RELATED APPLICATIONS

This application is a continuation application of PCT Patent Application No. PCT/CN2023/133170, filed on Nov. 22, 2023, which claims priority to Chinese Patent Application No. 202310125248X, entitled “METHOD FOR SOCIAL NETWORKING BASED ON VIRTUAL IMAGE, SYSTEM, STORAGE MEDIUM, AND TERMINAL DEVICE” and filed with the China National Intellectual Property Administration on Jan. 20, 2023, both of which are incorporated herein by reference in their entirety.

### FIELD OF THE TECHNOLOGY

The present disclosure relates to the field of information processing technologies, and in particular, to a method for social networking based on a virtual image, a system, a storage medium, and a terminal device.

### BACKGROUND OF THE DISCLOSURE

With the development of information processing technologies, currently, functions of social software become increasingly diversified. For example, social software can simulate a real-world scene (such as a bar or a library) to display a virtual scene, and can also realize real-time audio/video communication between users. In addition, a user can customize an image of his or her own style, participate in interactions on various topics, and so on.

Usually, a social software background actively pushes content such as various topics, various virtual scenes, and various related users to a terminal in which social software is installed, which is convenient for the user to expand his or her social circle by using the terminal. However, the range of content recommended by the social software background is often too large, and the user cannot easily find content that the user is interested in.

### SUMMARY

An embodiment of the present disclosure provides a method for social networking based on a virtual image, including: displaying a social application interface, the social application interface including an object screening control and a virtual image of a social object in a social application, the social application on the terminal device being logged in by a current social user, and each virtual image being associated with at least one social operation control; determining, in response to an operation performed on the object screening control, at least one first social object related to an online state of the current social user from the social application, the online state of the current social user describing a state of a virtual image of the current social user or a state of the current social user; and collapsing the object screening control in the social application interface and displaying a virtual image of the at least one first social object.

An embodiment of the present disclosure provides a social application system, including: an interface unit, configured to display a social application interface, the social application interface including an object screening control and a virtual image of a social object in a social application, the social application on the terminal device being logged in by a current social user, and each virtual image being associated with at least one social operation control; an object determining unit, configured to determine, in response to an operation performed on the object screening control, at least one first social object related to an online state of the current social user from the social application, the online state of the current social user describing a state of a virtual image of the current social user or a state of the current social user; and a displaying unit, configured to collapse the object screening control in the social application interface, and display a virtual image of the at least one first social object.

An embodiment of the present disclosure further provides a non-transitory computer-readable storage medium, the computer-readable storage medium having a plurality of computer programs stored therein, and the computer programs being configured to be loaded by a processor to perform the method for social networking based on a virtual image according to the embodiments of the present disclosure.

An embodiment of the present disclosure further provides a terminal device, including a processor and a memory, the memory being configured to store a plurality of computer programs, and the computer programs being configured to be loaded by the processor to perform the method for social networking based on a virtual image according to the embodiments of the present disclosure; and the processor being configured to implement each of the plurality of computer programs.

### BRIEF DESCRIPTION OF THE DRAWINGS

FIG. 1 is a schematic diagram of a method for social networking based on a virtual image according to an embodiment of the present disclosure.

FIG. 2 is a flowchart of a method for social networking based on a virtual image according to an embodiment of the present disclosure.

FIG. 3 is a flowchart of a method for social networking based on a virtual image according to another embodiment of the present disclosure.

FIG. 4 is a flowchart of a method for social networking based on a virtual image according to a specific application embodiment of the present disclosure.

FIG. 5a is a schematic diagram of a social application interface according to a specific application embodiment of the present disclosure.

FIG. 5b is another schematic diagram of a social application interface according to a specific application embodiment of the present disclosure.

FIG. 5c is another schematic diagram of a social application interface according to a specific application embodiment of the present disclosure.

FIG. 5d is a schematic diagram of an object screening sub-control according to a specific application embodiment of the present disclosure.

FIG. 5e is a schematic diagram of a social application interface when a user performs an enlarging pinch operation according to a specific application embodiment of the present disclosure.

FIG. 6 is a flowchart of another method for social networking based on a virtual image according to a specific application embodiment of the present disclosure.

FIG. 7 is a schematic structural diagram of a social application system according to another specific application embodiment of the present disclosure.

FIG. 8a is a flowchart of a method for interaction between users according to another specific application embodiment of the present disclosure.

FIG. 8b is a schematic diagram of a social application interface after an operation is performed on a matching control according to another specific application embodiment of the present disclosure.

FIG. 9 is a flowchart of another method for interaction between users according to another specific application embodiment of the present disclosure.

FIG. 10 is a flowchart of another method for interaction between users according to another specific application embodiment of the present disclosure.

FIG. 11 is a schematic diagram of a distributed system to which a method for social networking based on a virtual image is applied according to another application embodiment of the present disclosure.

FIG. 12 is a schematic diagram of a block structure according to another application embodiment of the present disclosure.

FIG. 13 is a schematic diagram of a logic structure of a social application system according to an embodiment of the present disclosure.

FIG. 14 is a schematic diagram of a logic structure of a terminal device according to an embodiment of the present disclosure.

### DESCRIPTION OF EMBODIMENTS

The following clearly and completely describes the technical solutions in embodiments of the present disclosure with reference to the accompanying drawings in the embodiments of the present disclosure. Apparently, the described embodiments are some of the embodiments of the present disclosure rather than all of the embodiments. All other embodiments obtained by a person of ordinary skill in the art based on the embodiments of the present disclosure without creative efforts shall fall within the protection scope of the present disclosure.

Terms such as “first”, “second”, “third”, and “fourth” (if exist) in the specification, claims, and accompanying drawings of the present disclosure are used for distinguishing between similar objects, and is not intended to describe a particular order or sequence. Data used in such a way are interchangeable in proper circumstances, so that the embodiments of the present disclosure described herein can be implemented in orders other than the order illustrated or described herein. In addition, terms “include”, “have”, and any other variants mean to cover the non-exclusive inclusion. For example, a process, method, system, product, or device that includes a series of steps or units is not necessarily limited to the listed steps or units, but may include other steps or units not expressly listed or inherent to the process, method, product, or device.

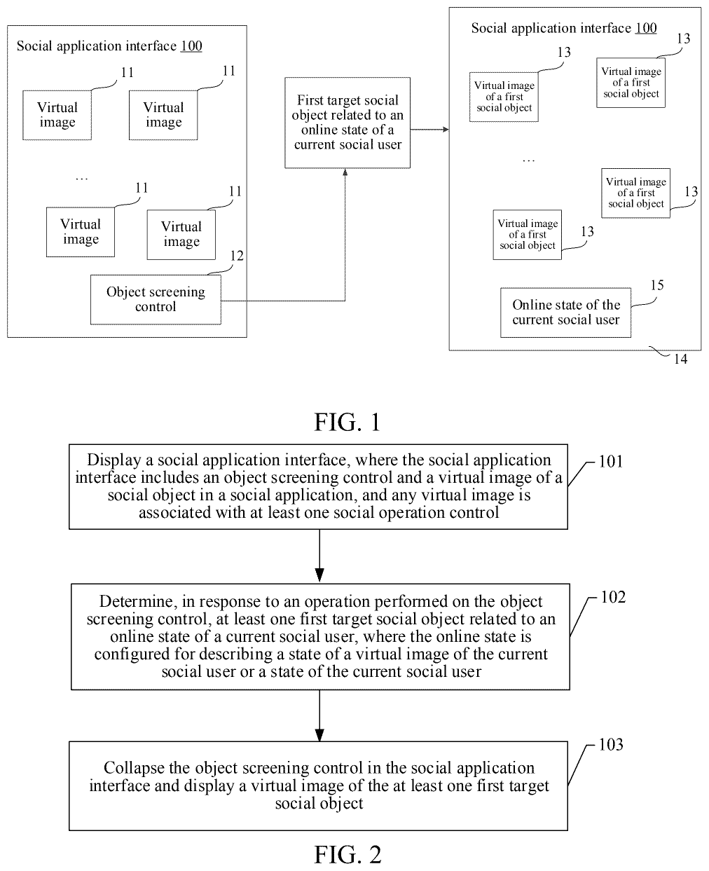

An embodiment of the present disclosure provides a method for social networking based on a virtual image, mainly applied to a social application system. As shown in FIG. 1, the social application system may implement a social process between users by using the following method:

displaying a social application interface 100, the social application interface 100 including an object screening control and a virtual image 11 of a social object in a social application, and each virtual image 11 being associated with at least one social operation control; determining, in response to an operation performed on an object screening control 12, at least one first social object (or first target social object) 13 related to an online state of a current social user from the social application, the online state of the current social user describing a state of a virtual image of the current social user or a state of the current social user; and collapsing the object screening control in the social application interface and displaying a virtual image of the at least one first social object.

FIG. 1 does not show a social operation control bound to each virtual image 11. The social operation control may be displayed in a social application interface in a plurality of manners. For example, an entire virtual image may be the social operation control, a part of the virtual image may be the social operation control, or the social operation control may be displayed around the virtual image. A specific form of the social operation control is not limited herein.

Further, a first area of the social application interface further displays the online state of the current social user. The first area may be an area such as a bottom, a top, or a side of the social application interface. A first area 14 shown in FIG. 1 is at the bottom of the social application interface, and displays an online state 15 of the current social user.

During specific implementation, the social application system may be applied only to a terminal device of a social application, and the terminal device of the social application implements the method for social networking based on a virtual image.

Alternatively, the social application system may be applied to a social application client and a social application server. The social application client provides an interface for interacting with a user. When the current social user performs an operation on a social application interface displayed by the social application client, the social application client initiates a corresponding request to the social application server. After executing each request, the social application server returns an execution result of the request to the social application client. The social application client may be a social application program installed in any terminal device, or may be a browser of a terminal device. The terminal device may include any of the following electronic devices: a smartphone, a portable computer such as a tablet computer, a desktop computer, an in-vehicle device, a wearable device, and the like.

In some embodiments of the present disclosure, the social application system determines a target social object based on the online state of the current social user. In this way, the current social user may dynamically set the online state, to define a determined target social object. This is convenient for the user to find a corresponding social object based on a requirement of the user, avoids a plurality of repeated matching operations required for matching a social object meeting the requirement of the user, and improves accuracy in a process of determining the target social object. In addition, the virtual image displayed in the social application interface is associated with the social operation control, so that it is convenient for the user to initiate a social operation on a specific social object, improving human-computer interaction efficiency in a social operation process of the user.

An embodiment of the present disclosure provides a method for social networking based on a virtual image, mainly performed by a terminal device, and specifically performed by the social application system installed in the terminal device. A flowchart is shown in FIG. 2, and the method includes the following operations.

Operation 101: Display a social application interface, where the social application interface includes an object screening control and a virtual image of a social object in a social application, and each virtual image is associated with at least one social operation control. In some embodiments, the social application on the terminal device is logged in by a current social user.

A social application system provides an interface for interacting with a user, and in this way, the user can implement the following functions by operating these interfaces: setting a personal virtual image of the user, performing real-time interaction (for example, real-time audio/video interaction) with a social user by using the personal virtual image, and participating in discussion on any topic, and the like. Specifically, the social application system displays the social application interface. The social application interface may generally include a personal virtual image of a current social user, a quantity of users that have registered in a social application, a friend that the current social user has followed and a social user that follows the current social user, a plurality of functional operation controls, and the like. Each functional operation control is configured to implement a specific function, for example, a function such as user setting or adding another friend.

In the embodiments of the present disclosure, the functional operation control displayed in the social application interface includes an object screening control, and may further include a state setting control, a matching control, and the like. When the user performs an operation on the object screening control, the social application system continues to perform the following operation 102. The state setting control is configured to set an online state of the current social user, and the matching control is configured to match, based on a set condition, a social object for interacting with the current social user from the social application.

Further, the social application interface further includes a virtual image of a social object in the social application. The social object is an object that can satisfy a social requirement of the current social user, and may specifically include a social user that satisfies the social requirement of the current social user, a chat scene that satisfies the social requirement of the current social user, a topic that satisfies the social requirement of the current social user, and the like. The current social user can interact with the social object through the social object of the social user, the current social user can join a created chat scene through the social object of the chat scene, and the current social user can participate in discussion on a specific topic through the social object of the topic.

In addition to the three types of objects, namely, the social user, the chat scene, and the topic, the social object may further include other types of objects, provided that a type of social interaction required by the current social user can be implemented. A specific form of the social object is not limited herein.

Further, any virtual image displayed in the social application interface is associated with a social operation control corresponding to a social object, and may be associated with one or more social operation controls. In this way, when the current social user performs an operation on a social operation control of any virtual image, in response to the operation performed on the social operation control, the social application system performs a social interaction operation (or referred to as a social operation) on the social object corresponding to the virtual image.

The virtual image may be displayed in the social application interface in any rendering form, such as a two-dimensional rendering form or a three-dimensional rendering form. In addition, because the virtual image is associated with the social operation control, when the virtual image is displayed in the social application interface, the corresponding social operation control may be displayed in a plurality of manners, which may specifically include, but is not limited to, the following several manners: using an entire virtual image as the social operation control; using a part of the virtual image as the social operation control; displaying the social operation control around the virtual image; displaying a part of information (a picture of a chat scene and the like) of a social object around the virtual image, and using the part of information of the social object as the social operation control, and the like.

In addition, the social operation performed on the social object is an operation of performing various social interaction activities with the social object. Specifically, based on different types of social objects, social operations for the social objects are also different. The social operation may include one or more. For example, a social object is a social user, a virtual image of thereof is a character virtual image of the social user, and a corresponding social operation may include initiating an interaction with the social user, following the social user, and the like; a social object is a chat scene, a virtual image thereof may be a planet, and a corresponding social operation may include joining the chat scene and viewing details of the chat scene; and a social object is a topic, a virtual image thereof may be another planet model, and a corresponding social operation may include: viewing details of the topic, and the like.

Operation 102: Determine, in response to an operation performed on the object screening control, at least one first target social object (or first social object) related to an online state of a current social user from the social application, where the online state of the current social user is configured for describing a state of a virtual image of the current social user or a state of the current social user. For example, the state of the current social user may be a text and/or image edited by the current social user indicating their state in real life or their current thoughts, etc.

Specifically, the online state of the current social user may be preset by the current social user in the social application system. When the process of this embodiment is initiated, the online state preset by the current social user may be determined as the online state of the current social user. Further, if the current social user does not preset the online state, when the process of this embodiment is initiated, a default online state may be determined as the online state of the current social user.

The online state of the current social user may be configured for describing the state of the virtual image of the current social user, including a posture of the virtual image, for example, a posture such as reading comics, drinking tea, or chatting; and a state of an apparatus for setting the virtual image, for example, a battery level of the apparatus for setting the virtual image. The online state of the current social user may alternatively describe a state of the current social user, such as a geographical area or weather of the current social user.

When the current social user performs an operation on the object screening control, the social application system mainly first determines the corresponding first target social object based on the online state of the current social user. In some embodiments, a final first target social object further needs to be determined based on the online state of the current social user with other information (for example, actual operation information of the user in the social application system).

Specifically, the social application system may determine different types of first target social objects based on online states of different types of current social users. The online states of the current social users may include, but are not limited to, the following several types of online states: an interaction-type online state, a content-type online state, and the like.

The interaction-type online state is an online state in which a plurality of users simultaneously participate, for example, an online state of “go dancing”, “want to chat”, or “want to go singing”. Such a type of online states allows simultaneous participation of a plurality of users and interaction between the users. In this case, the first target social object determined by the social application system includes, but is not limited to, at least one of the following social objects: a social object (namely, a social user) having the same online state as the current social user, or a chat scene related to the online state of the current social user. The chat scene is a scene in which a channel of a real-time session (such as an audio/video call) has been created, and the chat scene may be a chat scene of two or more users.

The content-type online state is an online state without simultaneous participation of a plurality of users, for example, “reading comics”. In this case, the first target social object determined by the social application system includes, but is not limited to, at least one of the following social objects: a social object (namely, a social user) having the same online state as the current social user, or a topic related to the online state of the current social user. The topic is a topic of content included in the online state of the current social user, and includes comment information, like information, and the like published by users on the topic.

Operation 103: Collapse the object screening control in the social application interface and display a virtual image of the at least one first social object.

Specifically, that the social application system performs operation 103 may include at least one of the following: collapsing the virtual image of the current social user and the object screening control in the social application interface and displaying the virtual image of the at least one first target social object; collapsing the object screening control in the social application interface and displaying the virtual image of the current social user and the virtual image of the at least one first target social object; or collapsing the object screening control in the social application interface and displaying the virtual image of the at least one first target social object. The “collapsing” operation herein may include: canceling displaying, hiding, or the like.

When collapsing the object screening control in the social application interface, the social application system further collapses other functional operation controls, such as the state setting control and the matching control. In addition, to display the virtual image of the first target social object more abundantly, a two-dimensional image of the first target social object may be displayed first, the three-dimensional model of the first target social object is then loaded based on the two-dimensional image of the first target social object, and the three-dimensional model is bound with the social operation control of the first target social object. When receiving a trigger operation, the social operation control performs a social operation based on the first target social object corresponding to the social operation control. In this way, a displaying speed of the first target social object can be improved by first displaying the two-dimensional image and then loading the three-dimensional model.

Specifically, the virtual image of the first target social object may be a virtual image in any form. For example, if the first target social object is a chat scene and a topic, the corresponding virtual image may be a planet model; and if the first target social object is a social user, the corresponding virtual image may be a person model, an animal model, or the like. In addition, the social application system further binds each virtual image with a social operation control of the first target social object, so that when a current social user performs an operation on the social operation control, the social operation control receives a trigger operation, and the social application system performs a social operation on the first target social object.

Further, the social application interface further includes a background space, used as a background of functional operation controls and virtual images of social objects. Therefore, when performing operation 103, the social application system further needs to collapse a current background space, and load a background space associated with the online state of the current social user. The background space may include at least one of the following backgrounds: a background picture, background audio, a background animation, or the like.

In another embodiment of the present disclosure, after the social application system performs operation 101, namely, displaying the social application interface, the current social user may perform an operation in the background space, for example, perform a gesture operation in the background space. In this case, when user operation information is received in the background space of the social application interface, and the user operation information is a preset refresh operation gesture, for example, an enlarging pinch operation, the social application system obtains a fourth target social object in response to the user operation information, and displays a virtual image of the fourth target social object in the social application interface.

Specifically, if the background space is a cosmic space, and the current social user performs the enlarging pinch operation in the background space, the social application system includes virtual images of target social objects that have been displayed currently into a star system of the cosmic space, displays the obtained social objects by using a star system model, explores and finds a new star system (including a new target social object) in the cosmic space, and displays the new target social object by using another star system model. When exploring target social objects in a new star system, the social application system may explore based on the online state of the current social user, or may explore based on other information.

When obtaining the fourth target social object, the social application system may search the entire social application based on specific information, for example, based on the online state of the current social user, or based on operation information of the user in the social application interface.

Further, the social application system may display the virtual image of the first target social object in a split-screen lazy loading manner. Specifically, the social application system first determines, based on a size of a displaying screen for displaying the social application interface, virtual images of a plurality of first target social objects that can be accommodated in the displaying screen at a time, and displays the determined virtual images of the plurality of first target social objects. When a screen sliding operation is received in the social application interface, the social application system determines and displays virtual images of a plurality of first target social objects that are accommodated in the displaying screen at a next time. In this way, the operations of determining and displaying virtual images of a plurality of first target social objects are cyclically performed, until virtual images of all first target social objects related to the online state of the current social user are displayed. Alternatively, when a quantity of times of sliding the displaying screen reaches a preset quantity of times, the social application system returns the virtual images of the plurality of first target social objects that are displayed for the first time.

Because the split-screen lazy loading is to first determine first target social objects to be displayed on a screen when the virtual image of the first target social object needs to be displayed, and then display the determined first target social object to be displayed, instead of determining all first target social objects related to the online state of the current social user and then displaying virtual images of all the first target social objects. In this way, frame freezing in a sliding process of the screen can be greatly reduced, and content occupation can be reduced.

In addition, operations 101 to 103 are a process in which the social application system actively initiates social object screening, and are mainly to determine a social object based on the online state of the current social user. In an embodiment of the present disclosure, the current social user may set the online state by using the social application system. Specifically,

The social application interface displayed in operation 101 further includes a state setting control. When the current social user performs an operation on the state setting control, the social application system jumps to a state setting interface in response to the operation on the state setting control, and the state setting interface includes a state control. When the current social user performs an operation on the state control, an online state selecting interface is displayed in response to the operation on the state control. The online state selecting interface includes at least one of the following: a plurality of candidate online states, an online-state automatic defining control, or an intelligently matched online state. The current social user may randomly select any candidate online state; or the current social user may operate online-state automatic defining control, to input the online state defined by the current social user; or the social application system intelligently matches a corresponding online state based on specific information (such as a location or a climate of a state of the current social user) through the intelligently matched online state. Finally, the online state determined in the online state selecting interface is determined as the online state of the current social user.

In the method of this embodiment, the social application interface displayed by the social application system includes the object screening control and virtual images of social objects. In this way, the first target social object related to the online state of the current social user is determined through the operation performed on the object screening control, the object screening control is collapsed, and the virtual image of the first target social object is displayed. The social application system determines the target social object based on the online state of the current social user. In this way, the current social user may dynamically set the online state, to define the determined target social object. This is convenient for the user to find a corresponding social object based on a requirement of the user, avoids a plurality of repeated matching operations required for matching a social object meeting the requirement of the user, and improves accuracy in a process of determining the target social object. In addition, the virtual image displayed in the social application interface is associated with the social operation control, so that it is convenient for the user to initiate a social operation on a specific social object, improving human-computer interaction efficiency in a social operation process of the user.

In a specific application embodiment, while performing operation 103, the social application system further displays the online state of the current social user in a first area of the social application interface, and after the displaying of the online state in the first area has reached a preset time (for example, Is), replaces the online state in the first area with the matching control. The matching control is configured to find, through matching based on a set condition, a social object to interact with the current social user from the social application. When the user performs an operation on the matching control, in response to the operation performed on the matching control, the social application system determines a social user in the online state of the current social user, to implement interaction, such as playing a game and real-time audio and a video, between the current social user and the matched social user.

Further, at least one candidate online state is displayed in a second area of the social application interface, and the first area and the second area are neighboring areas. When detecting a trigger operation of the current social user for the second area, or detecting a user operation of moving from the first area to the second area of the social application interface, the social application system displays the candidate online state in the first area, determines a related second target social object based on the candidate online state displayed in the first area, collapses a current virtual image in the social application interface, and displays a virtual image of the second target social object in the social application interface.

In this case, if the candidate online state currently displayed in the first area is inconsistent with the online state of the current social user, the social application system may directly replace the online state of the current social user with the candidate online state displayed in the first area, and the current social user does not need to set the online state through an operation performed on the state setting control, which is convenient for setting the online state of the current social user.

In another specific application embodiment, after performing operation 101, when the current social user performs an operation on the object screening control, while performing operation 102, the social application system may perform the following operations:
jumping to an object screening sub-control panel in response to the operation performed on the object screening control, where the object screening sub-control panel displays object screening sub-controls respectively corresponding to a plurality of preset online states, when the current social user performs an operation on any one of the object screening sub-controls, collapsing the panel in response to the operation performed on the object screening sub-control; and if an online state corresponding to the operated object screening sub-control is consistent with the online state of the current social user, performing the operation of determining, namely, operation 102; or if the online state corresponding to the operated object screening sub-control is inconsistent with the online state of the current social user, determining a third social object (or third target social object) related to the online state corresponding to the operated object screening sub-control, and displaying a virtual image of the third target social object in the social application interface.

In this case, the online state corresponding to the object screening sub-control operated by the current social user is not necessarily the online state of the current social user. In this way, if the online state corresponding to the object screening sub-control operated by the current social user is inconsistent with the online state of the current social user, the social application system may further directly replace the online state of the current social user with the online state corresponding to the object screening sub-control operated, which is convenient for setting the online state of the current social user.

Further, in another specific application embodiment, after the social application interface is displayed, the current social user may initiate interaction with a social user through the social application system. Specifically, the following several cases may be included, but are not limited thereto.

(1) The current social user is not in any chat scene. In other words, the current social user does not establish a chat session with any other social object. Specifically,

in one example, a virtual image of a social object displayed in the social application interface includes a virtual image of a social user, and a social operation control of the virtual image may be the virtual image. In this way, the current social user may perform an operation on the virtual image. In response to the operation performed on the virtual image, a chat establishing control that interacts with a social user in real time is displayed. The current social user performs an operation on the chat establishing control, to create and display a chat scene and an inviting control. Virtual images respectively corresponding to the current social user and a social object for interacting with the current social user are displayed in the chat scene. The inviting control is configured to invite at least one social object to join the chat scene. The at least one social object is in another chat scene or not in any chat scene.

In another example, the social application interface displayed by the social application system further includes the matching control. The user may perform an operation on the matching control. In response to the operation performed on the matching control, the social application system determines the online state of the current social user, determines a social object having the same online state as the current social user, displays a chat scene and the inviting control, and displays virtual images respectively corresponding to the current social user and the social object in the chat scene.

To implement that the current social user not in any chat scene initiates interaction with a social object, when the current social user performs an operation on the chat establishing control through the social application interface, the social application system first determines chat scene states of the current social user and the social object, and then initiates a session with the social object based on the chat scene state. The chat scene state is configured for describing whether a user is currently in a chat scene.

Specifically, if a chat scene state of the current social user indicates that the current social user is not in a chat scene, and a chat scene state of the social object indicates that the social object is not in the chat scene, the social application system first creates a chat scene, adds the current social user and the social object to the created chat scene, and establishes a chat session with the social object.

If the chat scene state of the social object indicates that the social object is in a chat scene and the chat scene state of the current social user indicates that the current social user is not in the chat scene, the social object is instructed to first exit the current chat scene; and if the social object agrees to exit the current chat scene, the social application system first creates a chat scene, adds the social object to the created chat scene, and establishes a chat session between the current social user and the social object.

(2) The current social user is currently in a chat scene. In other words, the current social user establishes a chat session with another social user. Specifically,

in one example, the current social user is currently in a chat scene, and the social application system displays the chat scene and the inviting control. The current social user performs an operation on the inviting control, and a list of social users to be invited is displayed in response to the operation performed on the inviting control. When an invitation to at least one social user in the list of social users to be invited is received, if any social object of the at least one social user agrees to join the chat scene, the social application system displays a virtual image of the any social object in the chat scene.

Further, if the current social user and a social object of the at least one social user are in the same chat scene, the social application system may further perform a user prompt. The user prompt is configured to prompt that the social object invited by the current social user is in the chat scene of the current social user. The social application system may further jump to displaying at least one interaction control (such as an audio/video control, a game play control, and a mutual friend control) for interacting with the social object. By using these interaction controls, the social application system may directly interact with the social object.

To implement that the current social user in a chat scene initiates interaction with a social object, the current social user initiates invitation to at least one social user by using the inviting control. When any social object of the at least one social user agrees to the invitation, the social application system first determines chat scene states of the current social user and the social object, and initiates a session with the at least one social object based on the chat scene states. If the chat scene state of the current social user indicates that the current social user is in a chat scene, and the chat scene state of the any social object indicates that the any social object is not in the chat scene, the social application system directly adds the any social object to the chat scene that the current social user is in, and establishes a chat sub-session to the any social object.

If the chat scene states of the any social object and the current social user indicate that the any social object and the current social user are in different chat scenes, the any social object is instructed to exit a current chat scene; and if the any social object agrees to exit the current chat scene, the any social object is added to a chat scene that the social user is currently in, and a chat sub-session with the any social object is established.

In another example, the current social user is currently in a chat scene, and the social application system displays the chat scene. The chat scene includes a virtual image of a social user. When the current social user performs an operation on a virtual image of a social object in the chat scene, at least one interaction control (such as an audio/video control, a game playing control, and a mutual friend control) for interacting with the social object is displayed in response to the operation performed on the virtual image. In response to an operation performed on any interaction control, the social application system directly interacts with the social object.

To implement interaction between the current social user and a social object in the same chat scene, when the current social user performs an operation on an interaction control of a social object, the social application system determines that chat scene states of the current social user and the social object indicate that the current social user and the social object are in the same chat scene. In other words, a chat session is already established between the current social user and the social object. The social application system may first set a chat sub-session between the current social user and the social object. A mode of the chat sub-session is a private chat mode. In other words, a third user in the current chat scene is blocked. Moreover, interaction, such as an audio/video call, and other forms of interaction, with the social object is implemented through the chat sub-session.

In this way, an audio/video session between users may be established in various chat scene online states of the users, to implement interaction between the users and expand a range of interaction between the users.

Further, in another specific application embodiment, after displaying the social application interface, the social application system may further receive an invitation from the social object for interaction. Specifically, the following several cases may be included, but are not limited thereto.

### (1) The Current Social User is not in any Chat Scene

In one example, when the social application system pops up an invitation selecting control in the social application interface, where the invitation selecting control is configured to agree or refuse to join a chat scene of a social user performing invitation, and the current social user agrees to join, the social application system receives information about agreeing to join the chat scene of the social user performing invitation, displays the chat scene of the social user performing invitation, and displays virtual images of the current social user and the social user performing invitation in the chat scene of the social user performing invitation.

To implement that the current social user not in any chat scene joins a chat scene of a social user, the social application system determines a chat scene state of the current social user. If the chat scene state of the current social user indicates that the current social user is not in a chat scene, the social application system directly adds the current social user to a chat scene of a social user performing invitation. Through a chat session or a chat sub-session between the current social user and the social user performing invitation, audio/video interaction, and the like, between the current social user and the social user performing invitation are implemented.

### (2) The Current Social User is in a Chat Scene

In one example, when the social application system pops up the invitation selecting control in a displayed chat scene, where the invitation selecting control is configured to agree or refuse to join a chat scene of a social user performing invitation, and the current social user agrees to join, the social application system receives information about agreeing to join the chat scene of the social user performing invitation, currently displays a chat scene that the current social user is currently in, and jumps from the chat scene to the chat scene of the social user performing invitation. In this case, the current social user and the social user performing invitation are in different chat scenes, or the current social user is in a chat scene, and the social user performing invitation is not in a chat scene.

In another example, when the social application system pops up the invitation selecting control in a displayed chat scene, where the invitation selecting control is configured to agree or refuse to join a chat scene of a social user performing invitation, and the current social user agrees to join, the social application system receives information about agreeing to join the chat scene of the social user performing invitation, and directly displays at least one interaction control (such as an audio/video control, a game play control, and a mutual friend control) for interacting with the social user performing invitation. In response to an operation performed on any interaction control, the social application system directly interacts with the social user performing invitation in real time. In this case, the current social user and the social user performing invitation are in the same chat scene.

To implement that the current social user in a chat scene joins another chat scene of another social user, the social application system determines chat scene states of the current social user and a social user performing invitation. If the chat scene states of the current social user and the social user performing invitation indicate that the current social user and the social user performing invitation are in different chat scenes, the current social user exits a current chat scene, and joins the chat scene of the social user performing invitation. Through a chat sub-session between the current social user and the social user performing invitation, audio/video interaction, and the like, between the current social user and the social user performing invitation are implemented.

If the chat scene states of the current social user and the social user performing invitation indicate that the current social user and the social user performing invitation are in the same chat scene, the current social user directly joins the chat scene of the social user performing invitation. Through a chat sub-session between the current social user and the social user performing invitation, audio/video interaction, and the like, between the current social user and the social user performing invitation are implemented.

A specific application embodiment of the present disclosure provides a method for social networking based on a virtual image. The method mainly includes: the foregoing social application system is used in a social application client of a terminal device and a social application server, and the method for social networking based on a virtual image is implemented through interaction between the social application client and the social application server. A flowchart is shown in FIG. 3, and the method includes the following operations.

Operation 201: The social application client displays a social application interface, where the social application interface includes an object screening control and a virtual image of a social object in a social application, and initiates a screening request to the social application server when a current social user performs an operation on the object screening control.

The current social user may actively initiate the screening request to the social application server through the social application client, to request the social application server to determine at least one first target social object related to an online state of the current social user for the social application client.

The screening request may include the online state of the current social user. In this way, when the current social user needs to perform an operation on the object screening control, the social application client first obtains the online state of the current social user, adds the online state of the current social user to the screening request, and sends the screening request to the server.

Operation 202: After receiving the screening request, the social application server determines the online state of the current social user based on the screening request.

Specifically, if the screening request initiated by the social application client includes an online state of the current social user, the social application server may directly determine the online state as the online state of the current social user of the user. In this case, if the online state included in the screening request is inconsistent with an online state of the current social user stored in the social application server, the online state of the current social user stored in the social application server may be replaced with the online state included in the screening request. In this way, the online state of the current social user may be quickly set, which is convenient to set the online state of the current social user.

If the screening request initiated by the social application client does not include the online state of the current social user, an online state of the current social user corresponding to user information of the determined current social user may be found in local storage based on user information of the current social user included in the screening request.

Operation 203: The social application server determines at least one first target social object related to the online state of the current social user from the social application, and pushes the at least one first target social object to the social application client, and the social application client collapses a current virtual image and functional operation controls (including the object screening control), and displays a virtual image of the at least one first target social object.

Specifically, if the online state of the current social user is an interaction-type online state, the first target social object related to the online state of the current social user and determined by the social application server includes at least one of the following: a social user having the same online state as the current social user; or a chat scene related to the online state of the current social user. For example, the online state of the current social user is “dancing”, the determined first target social object may include a social user whose online state is set with “dancing”, a virtual scene “xx dancing hall” or “xx pub” in which a chat session has been created, or the like.

If the online state of the current social user is a content-type online state, the first target social object related to the online state of the current social user and determined by the social application server may include at least one of the following: a social user having the same online state as the current social user, or a topic related to the online state of the current social user. For example, the online state of the current social user is “reading comics”, the determined first target social object may include a social user whose online state is set with “reading comics”; a topic related to “comics” includes multimedia files related to comics and published by a plurality of users, or the like.

Operations 201 to 203 are a process of determining the target social object for the screening request initiated by the social application client. In another embodiment, the social application client may further initiate a user matching process to the social application server. Specifically,

The social application client may further include a matching control in a displayed social application interface. When the current social user performs an operation on the matching control, the social application client initiates a matching request. When receiving the matching request sent by the social application client, and the social application server determines, based on the online state of the current social user carried in the matching request, a social object (specifically, another social user) related to the online state of the current social user, and pushes the social object to the social application client, the social application client may directly initiate a session request with a social application client of the social object.

In this embodiment, because the social application server determines the target social object based on the online state of the current social user, the current social user may dynamically set the online state, to define a target social object to be pushed to the social application client. This is convenient for the current social user to find a corresponding social object based on a requirement of the current social user, avoids a plurality of repeated matching operations required for matching a social object meeting the requirement of the current social user, and improves accuracy in a process of determining the target social object.

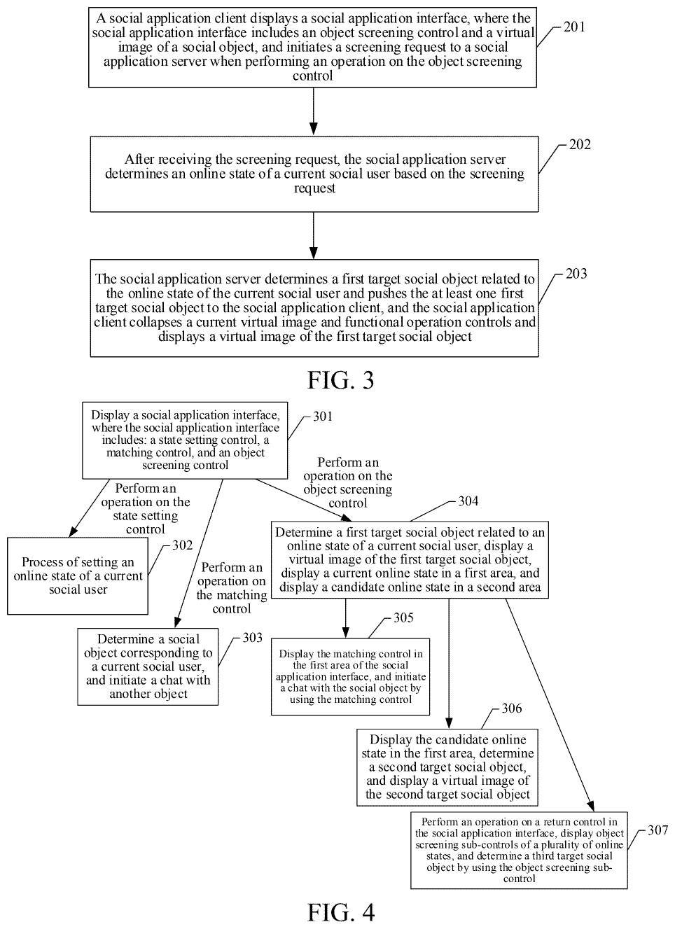

The following describes the method for social networking based on a virtual image in the present disclosure by using a specific application example. The method for social networking based on a virtual image in this embodiment is mainly applied to a social application system. Specifically, as shown in FIG. 4, a method for social networking based on a virtual image in this embodiment includes the following operations.

Operation 301: A social application system displays a social application interface, where the social application interface includes a personal virtual image of a current social user, a quantity of users online in a social application, and virtual images of social objects, such as virtual images of a social user, a chat scene, and a topic, each virtual image is associated with a social operation control corresponding to the social object, and the social application interface further includes: a state setting control, a matching control, an object screening control, and the like. The social application interface may further include a background space.

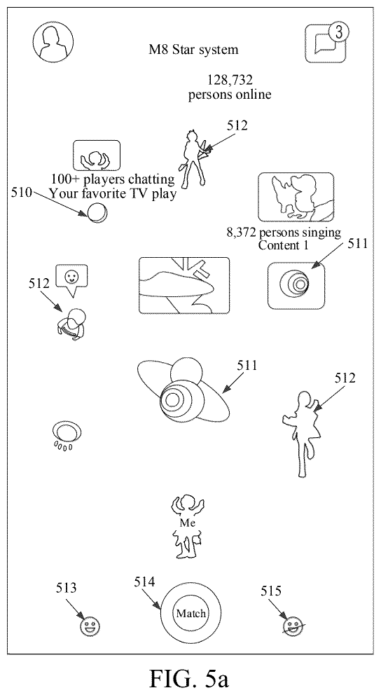

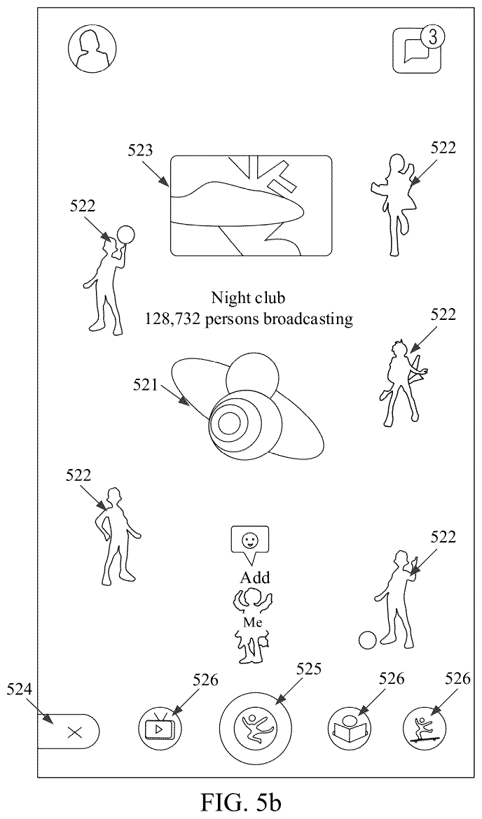

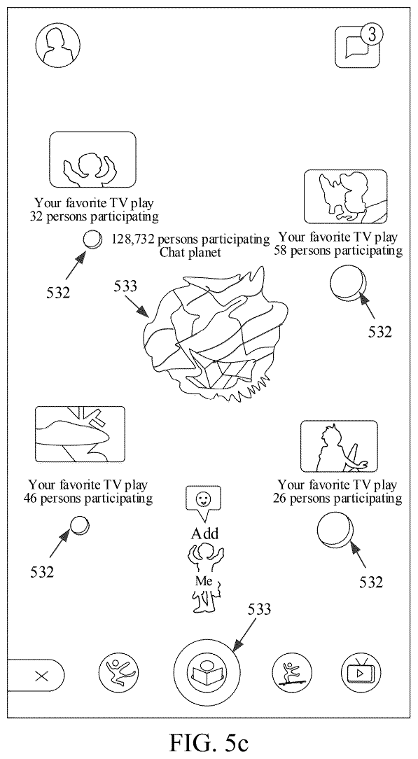

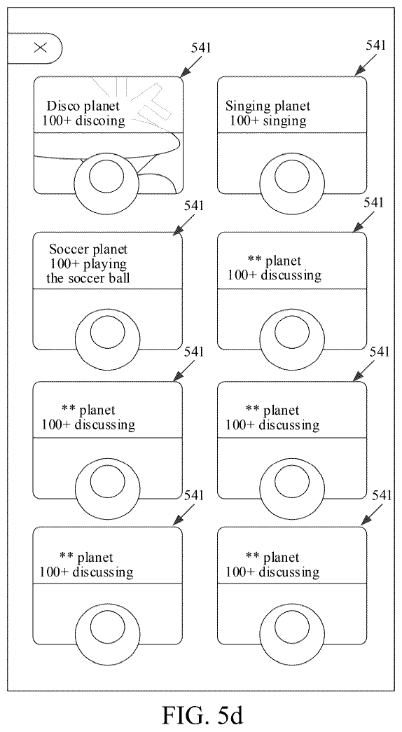

For example, as shown in FIG. 5a, a social application interface displayed by the social application system mainly uses a universe model as a background space, displays a social user in the social object by using a character image, and displays a chat scene and a topic by using a planet model. As shown in FIG. 5a, the social application interface includes a planet model 510 of a topic, a planet model 511 of a chat scene, and virtual images 512 of social users. An arrangement sequence of virtual images of social users in the background space may be displayed based on sorting logic: mutual friends, people followed, followers, and strangers of the current social user. The current social user may slide a screen left and right for viewing. The social application system loads a virtual image of a new social object. When the screen is slid for more than a preset number of times (for example, three times), the social application system may return to display a virtual image of a social object for the first time. In addition, three controls at the bottom of the social application interface are sequentially from left to right: a state setting control 513, a matching control 514, and an object screening control 515.

A social operation control corresponding to a virtual image of a social user is the virtual image, or may be a user operation control at the top of the virtual image. A social operation control corresponding to a virtual image of a topic may be a picture of a topic at the top of a planet. A social operation control corresponding to a virtual image of a chat scene may be a picture of a chat scene at the top of a planet.

Operation 302: When the current social user performs an operation on the state setting control in the social application interface, the social application system enters a process of setting an online state of the current social user. Specifically, the social application interface jumps to a state setting interface. The state setting interface includes a state control. When the current social user performs an operation on the state control, the social application system displays an online state selecting interface. The online state selecting interface may include a plurality of candidate online states, an online-state automatic defining control, and an intelligently matched online state. The current social user determines an online state through the online state selecting interface, and the social application system uses the online state determined through the online state selecting interface as the online state of the current social user.

If the current social user does not determine any online state on the online state selecting interface, the social application system may determine a default online state (for example, a floating state) as the online state of the current social user.

Operation 303: When the current social user performs an operation on the matching control in the social application interface, the social application system determines a social object (which is mainly another social user) related to the online state of the current social user, and then initiates a session process with the social object.

In this case, when the social application system determines the social object based on the matching control, a social user may be determined based on other information instead of being matched based on the online state of the current social user.

Operation 304: When the current social user performs an operation on the object screening control in the social application interface, the social application system determines at least one first target social object related to the online state of the current social user, and the social application system collapses a current virtual image and functional operation controls, including the object screening control, state setting control, matching control, and the like, in the social application interface, displays a virtual image of the at least one first target social object, displays the online state of the current social user in a first area of the social application interface, and displays a plurality of candidate online states (such as watching television, reading comics, and skateboarding) in a neighboring area of the first area, namely, a second area.

Specifically, the social application system may determine, based on a type of the online state of the current social user, the first target social object related to the online state of the current social user. If the online state of the current social user is an interaction-type online state, the first target social object determined by the social application system may include: a social user having the same online state as the current social user; and a related chat scene. For example, a social application interface shown in FIG. 5b displays a planet model 521 of a chat scene related to an online state “discoing” of a current social user and virtual images 522 of social users. Specifically, the planet model in the displayed chat scene is associated with: a social operation control (an image 523 floating on a planet) configured to join a chat scene and a social operation control (a body 521 of the planet) configured to view details of a chat scene, and a displayed background space (including a background picture and background music) corresponds to the online state “discoing” of the current social user. When the current social user taps the body (the control configured to view details of a chat scene) 521 of the planet, the social application system displays a details interface of a corresponding chat scene, and when the current social user taps the image 523 floating on the planet, the current social user joins the chat scene. When a virtual image 522 of a social user is tapped, personal information and a recently posted online state of the social user can be viewed, and private chat, voice, video, or expression interaction can be performed with the social user. In addition, when the first target social object related to the online state of the current social user is determined, the following is displayed at the bottom of the social application interface: a return control 524, an online state 525 of the current social user, and candidate online states 526 in the second area.

If the online state of the current social user is a content-type online state, the first target social object determined by the social application system may include at least one of the following: a social user having the same online state as the current social user, or a related topic. For example, a social application interface shown in FIG. 5c displays a virtual image 531 of a topic related to an online state “reading comics” 533 of the current social user and virtual images 532 of sub-topics included in the topic. Specifically, the virtual images are associated with: a social operation control (a body 531 or 532 of a planet) for viewing details of a topic or a sub-topic, and a displayed background space (including a background picture and background music) of the planet corresponds to the online state “reading comics” of the current social user. When the current social user taps the body 531 or 532 of the planet, the social application interface displays a details interface of a corresponding topic or sub-topic, and the details interface includes information about a social user related to the topic or sub-topic, content posted by a social user, and content participating in discussion of the topic or sub-topic. In this way, the current social user may randomly match a social user that has discussed the topic or sub-topic for audio/video communication.

Operation 305: After the displaying of the online state in the first area of the social application interface has reached a preset time (for example, Is), the social application system replaces the matching control in the first area with the online state of the current social user. In this way, the current social user may perform an operation on the matching control, and the social application system determines a social object related to the online state of the current social user, and then initiates a session process with the social object.

Operation 306: When the current social user performs an operation in the second area of the social application interface, or moves from the first area to the second area, the social application system displays, in the first area, a candidate online state previously displayed in the second area, determines a related second target social object based on the candidate online state, and displays a virtual image of the second target social object in the social application interface.

In this case, if the social application system finds that an online state of the current social user in the system is inconsistent with the candidate online state displayed in the first area, the social application system may replace the online state of the current social user with the candidate online state displayed in the first area.

Operation 307: In addition to the online state of the current social user in the first area and the candidate online state in the second area, the social application interface further includes a return control. When the current social user performs an operation on the return control, the social application system jumps to an object screening sub-control panel, and displays object screening sub-controls of a plurality of online states in the object screening sub-control panel. When the current social user performs an operation on any object screening sub-control, the social application system collapses the object screening sub-control panel. In addition, if an online state corresponding to the operated object screening sub-control is consistent with the online state of the current social user, the social application system returns to display the virtual image of the first target social object. If the online state corresponding to the operated object screening sub-control is inconsistent with the online state of the current social user, a third target social object related to the online state corresponding to the operated object screening sub-control is determined, and a virtual image of the third target social object is displayed in the social application interface.

For example, the social application interface shown in FIG. 5b includes the return control 524. When the current social user performs an operation on the return control 524, the social application system jumps to an object screening sub-control panel (as shown in FIG. 5d). The object screening sub-control panel shown in FIG. 5d includes object screening sub-controls 541 of eight online states. An object screening sub-control corresponding to an online state “go to disco” of a current social user preset in the system preset by the current social user is ranked first, and other object screening sub-controls are object screening sub-controls corresponding to other online states in the social application system.

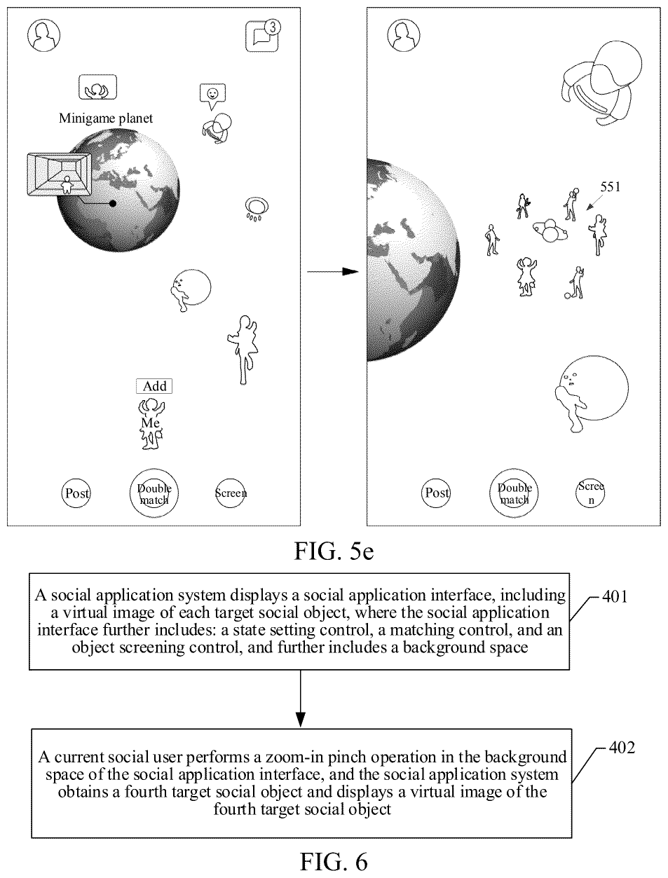

In another embodiment, as shown in FIG. 6, another method for social networking based on a virtual image in this embodiment includes the following operations.

Operation 401: A social application system displays a social application interface, where the social application interface includes a personal virtual image of a current social user, a quantity of users online in a social application, and a virtual image of each target social object, such as a virtual image of a social user, a chat scene, or a topic, and the social application interface further includes: a state setting control, a matching control, an object screening control, and the like. In addition, the social application interface includes a background space.

Operation 402: The current social user performs a zoom-in pinch operation in the background space of the social application interface, and the social application system obtains a fourth target social object, and displays a virtual image of the fourth target social object in the social application interface.

For example, as shown in FIG. 5e, the zoom-in pinch operation is performed in a universe space (background space) of the social application interface, the social application system includes currently displayed social objects in a star system, displays the obtained social objects by using a star system model, explores a new star system 551 (including a new target social object) in the universe space, and displays the fourth target social object by using another star system model 551. During exploration in the universe space, an effect that another star system model 551 is gradually enlarged and clearer may be displayed in the social application interface, and finally, the effect is displayed in the middle of the social application interface.

In a specific application embodiment, to implement the foregoing object screening and displaying of a virtual image of a social object by the social application system, the social application system may implement the following processing on a data layer.

When the social application interface is displayed, the following needs to be pulled: planet displaying information, a three-dimensional virtual image of a social user, information about the current social user, alternative topic information, chat scene information, and the like; a two-dimensional image, a virtual image, and selected interaction information of each piece of planet information; a two-dimensional image of a virtual image, the virtual image, and an online state of each user, where an action identifier of a three-dimensional virtual image may be positioned by using an online state identifier and a virtual image identifier of the user; and a default online state of each user, for example, a floating online state; and when the social application system needs to display a new social object again, the social application system may clean data in a memory and reload information about the new social object to the memory.

In addition, the social application system may display the virtual image of each target social object in the following manner:

the social application system first loads a two-dimensional image of each target social object, then dynamically loads a three-dimensional model of each target social object, and binds the three-dimensional model with a social operation control corresponding to the target social object. In this way, a displaying speed of each target social object can be improved, and it is convenient for the current social user to perform an operation on the target social object. Further, when split-screen displaying the virtual image of each target social object, the social application system may use a split-screen lazy loading manner. Specifically, the social application system displays virtual images of some target social objects on a displaying screen. When the user performs a refresh operation on the social application interface, the social application system obtains a new target social object based on the refresh operation of the current social user, and displays a virtual image of the new target social object. In this way, frame freezing in a sliding process of the displaying screen can be greatly reduced, and memory occupation can be reduced.

Further, when displaying the virtual image of each target social object, the social application system may calculate a point position of the virtual image of each target social object based on a hexagon principle of a displaying screen layout, to place the virtual image of each target social object at a corresponding position on the displaying screen based on the point position of each target social object.

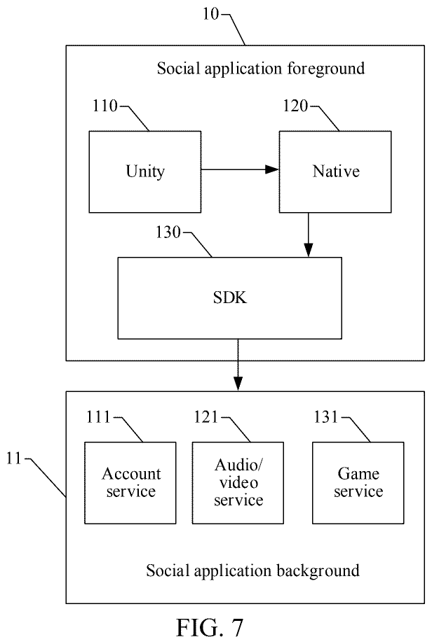

In another embodiment, to implement real-time session-based interaction with any social user, as shown in FIG. 7, it may be set that the social application system may include: a social application foreground 10 and a social application background 11 that include the following structures. The social application foreground 10 and the social application background 11 may be deployed in the same terminal device. Alternatively, the social application foreground 10 may be deployed in a social application client, and the social application background 11 is deployed in a social application server. Specifically,

the social application foreground 10 includes a user interface (Unity) 110, an interface (Native) 120, and a software development kit (SDK) 130. Three-dimensional rendering of most scenes and users is implemented by using the Unity 110, and three-dimensional rendering of an interface (UI) component is implemented by using the Native 120. Real-time audio/video communication is performed by the Native 120 invoking the SDK 130, and then a corresponding request is initiated to the social application background 11 by using the SDK 130.

In this way, device performance can be better used by using the Unity 110 and the Native 120, and performance consumption and operation frame freezing of the social application foreground 10 can be reduced, thereby improving user experience.

The social application background 11 includes an account service 111, a media service 121, a game service 131, and the like, to respond to a related request of the social application foreground 10.

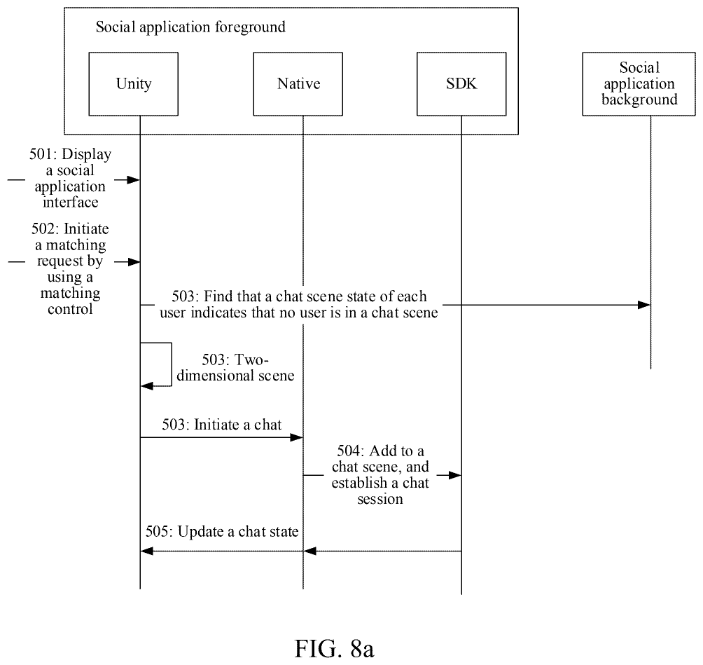

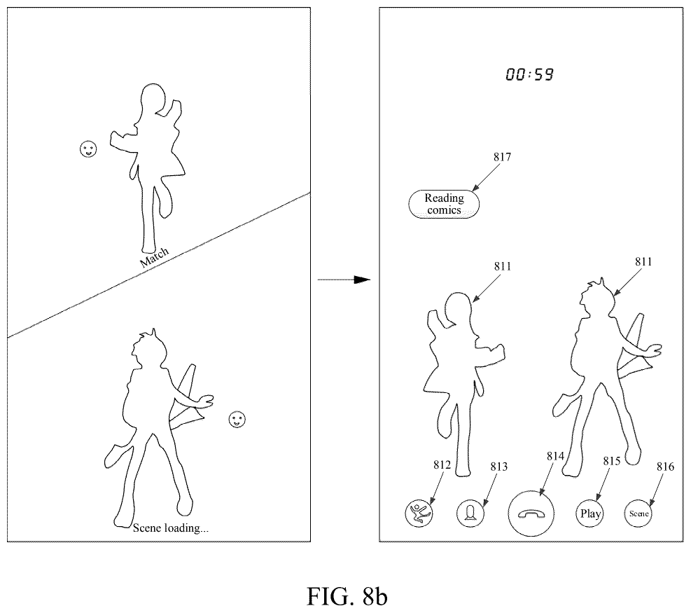

Specifically, in one example, as shown in FIG. 8a, real-time session-based interaction between a current social user and a social object (namely, a social user) may be implemented through the following operations.

Operation 501: The social application foreground 10 displays a social application interface, where the social application interface includes a personal virtual image of the current social user, a quantity of users online in a social application, and virtual images of a plurality of social objects, such as virtual images of a social user, a chat scene, a topic, and the like, each virtual image is associated with a social operation control of the social object, and the social application interface further includes: a state setting control, a matching control, an object screening control, and the like.

Operation 502: When the current social user performs an operation on the matching control in the social application interface, the social application foreground 10 initiates a matching request to the social application background 11, and after receiving the matching request, the social application background 11 first determines an online state of the current social user, determines a social object having the same online state as the current social user, and pushes the social object to the social application foreground 10.

Operation 503: When the social application foreground 10 receives the social user pushed by the social application background 11, the Unity 110 of the social application foreground 10 first determines, from the social application background 11 by using the SDK 130, chat scene states respectively corresponding to the current social user and the social object, and if the chat scene state of the current social user indicates that the current social user is not in the chat scene, and the chat scene state of the social object indicates that the social object is not in the chat scene, the Unity 110 directly displays a two-dimensional image of the chat scene, and invokes the Native 120 to initiate a session.

Operation 504: The Native 120 invokes the SDK 130 to establish a chat scene, adds the current social user and the social object to the created chat scene, and establishes a chat session to the social object.

Operation 505: After successfully establishing a chat session, the SDK 130 instructs, through callback, the Native 120 to update the current chat states of the social user and the social object, and the Native 120 calls back the Unity 110, to update the chat state in the interface to real-time interaction of being in a chat.

For example, as shown in the social application interface of the current social user in FIG. 8b, when the current social user initiates social user matching by using the matching control, the social application foreground 10 of the current social user displays a picture of “Scene loading” (a picture on the left in FIG. 8b) in the social application interface in a process of performing operations 502 to 505. After operation 505 is performed, the chat state is updated in the social application foreground 10, and the social application foreground 10 displays a chat scene including virtual images 811 of the current social user and the social object, displays an online state 817 of each user, for example, reading comics, and further displays interaction controls. For example, the interaction controls from left to right at the bottom of the social application interface are: an inviting control (an animated character) 812, an audio/video control 813, a hang-up control 814, a game control “Play” 815, and a chat scene change control “Scene” 816. In this way, by using the interaction control, social application foregrounds 10 of the current social user and the social object can perform various types of interaction, such as real-time audio/video communication, game play, and changing chat scenes.

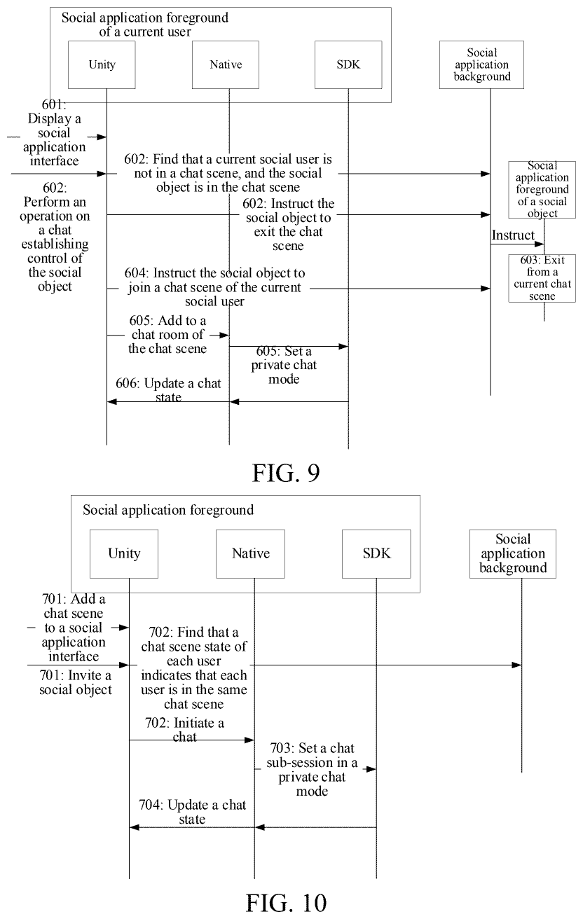

In another example, as shown in FIG. 9, the real-time session-based interaction between the current social user and the social object may be implemented through the following operations.

Operation 601: The social application foreground 10 displays a social application interface, where the social application interface includes a personal virtual image of the current social user, a quantity of users online in a social application, and virtual images of a plurality of social objects, such as virtual images of a social user, a chat scene, a topic, and the like, each virtual image is associated with a social operation control of the social object, and the social application interface further includes: a state setting control, a matching control, an object screening control, and the like. The social application interface further includes a background space.

Operation 602: When the current social user taps a virtual image of a social user displayed in the social application interface, the social application foreground 10 displays a chat establishing control of the social user. When the current social user performs an operation on the chat establishing control, the Unity 110 of the social application foreground 10 first determines, from the social application background 11 by using the SDK 130, chat scene states respectively corresponding to the current social user and the social object. If the current social user is not in a chat scene, and the social object is in a chat scene, the Unity 110 instructs, through the social application background 11, a social application foreground 10 of the social object to exit the current chat scene.

Operation 603: If the social object agrees to exit the current chat scene, a Unity 110 included in the social application foreground 10 of the social object invokes a Native 120 to exit the current chat scene.

Operation 604: The Unity 110 included in the social application foreground 10 of the current social user invokes an interface of the social application background to add the social object to a chat scene of the current social user, where if the current social user is not in a chat scene currently, the social application foreground 10 needs to first establish a chat scene and then add the social object to the chat scene.

Operation 605: The Unity 110 of the social application foreground 10 of the current social user invokes the Native 120 to add the social object to a session room in the current chat scene, that is, establish a chat sub-session to the social object, and set a private chat mode of the chat sub-session.

Operation 606: The Native 120 returns a current chat state between the social user and the social object to the Unity 110, to update the chat state in the interface.

In another example, as shown in FIG. 10, the real-time session-based interaction between a current social user and a social user may be implemented through the following operations.

Operation 701: The social application foreground 10 displays a social application interface, where the social application interface includes a personal virtual image of the current social user, a quantity of users online in a social application, and virtual images of a plurality of social objects, such as virtual images of a social user, a chat scene, a topic, and the like, each virtual image is associated with a social operation control of the social object, and the social application interface further includes: a state setting control, a matching control, an object screening control, and the like. The social application interface further includes a background space.

When the current social user taps a virtual image of a chat scene displayed in the social application interface, the social application foreground 10 joins the chat scene. The social application foreground 10 displays the chat scene and an inviting control. The chat scene includes virtual images of a plurality of social objects. When the current social user invites a social object in a list of social users to be invited by using the inviting control, the following operation 702 is performed.

Operation 702: The Unity 110 of the social application foreground 10 determines, from the social application background 11 by using the SDK 130, chat scene states respectively corresponding to the current social user and the social object, and if the current social user and the social object are in the same chat scene, the Unity 110 invokes the Native 120 to initiate a session.

Operation 703: The Native 120 invokes the SDK 130 to set a chat sub-session between the current social user and the social object in the chat scene, where a mode of the chat sub-session is a private chat mode.

Operation 704: The Native 120 returns a current chat state between the social user and the social object to the Unity 110, to update the chat state in the interface.

When operation 702 in which it is determined that current social user and the social object are in the same chat scene is performed, the Unity 110 further performs a user prompt. The user prompt is configured to prompt that a social user invited by the current social user is in the chat scene of the current social user. After operation 704 is performed, the social application system further jumps to displaying at least one interaction control (such as an audio/video control, a game play control, and a mutual friend control) for interacting with the social object. By using the interaction controls, the social application system directly performs real-time interaction with the social object.

In this way, an audio/video session between users may be established in various chat scene states of the users, to implement real-time interaction between the users and expand a range of interaction between the users.

The following describes the method for social networking based on a virtual image in the present disclosure by using another specific application example. The social application system in the embodiments of the present disclosure is mainly a distributed system 100. The distributed system may include a client 300 and a plurality of nodes 200 (computing devices in any form in an access network, such as a server and a user terminal). The client 300 is connected to the nodes 200 in a network communication form.

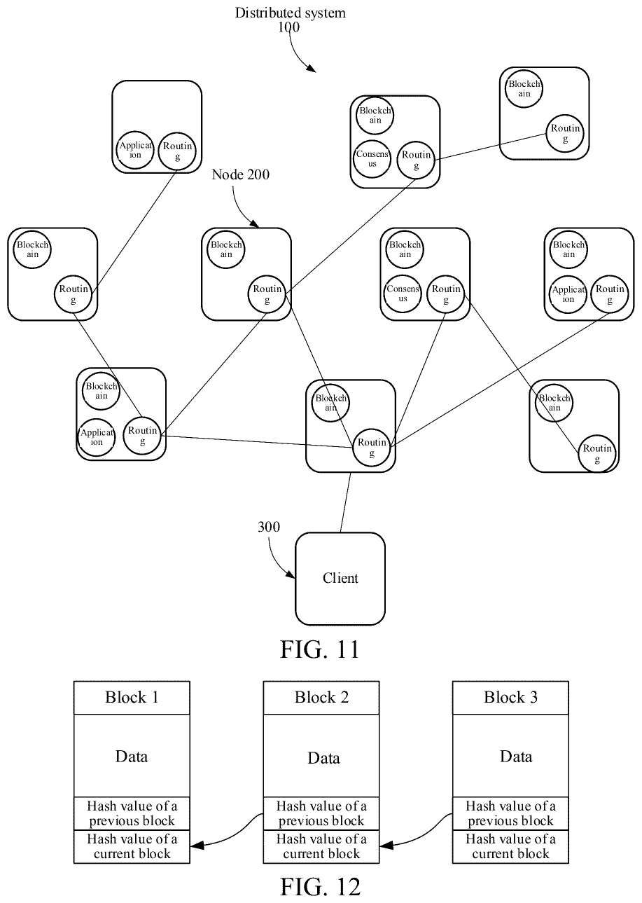

An example in which the distributed system is a blockchain system is used. FIG. 11 is a schematic structural diagram of a distributed system 100 used in a blockchain system according to an embodiment of the present disclosure. The distributed system 100 includes a plurality of nodes 200 (computing devices in any form in an access network, such as a server and a user terminal) and a client 300. A peer-to-peer (P2P) network is formed between the nodes. The P2P protocol is an application-layer protocol running over a transmission control protocol (TCP). In the distributed system, any machine such as a server or a terminal may be added to become a node. The node includes a hardware layer, an intermediate layer, an operating system layer, and an application layer.

Referring to functions of nodes in the blockchain system shown in FIG. 11, the functions include the following.

(1) Routing: it is a basic function of a node, and is configured for supporting communication between nodes.

In addition to the routing function, the node may further have the following functions.

(2) Application: it is deployed in a blockchain, configured to implement a specific service based on an actual service requirement, record data related to function implementation to form recorded data, add a digital signature to the recorded data to represent a source of task data, and send the recorded data to another node in the blockchain system, so that the another node adds the recorded data to a temporary block when a source and integrity of the recorded data is successfully verified.

For example, the service implemented by the application includes code for implementing a social function based on a virtual image, and the social function based on the virtual image mainly includes:
displaying a social application interface, where the social application interface includes an object screening control and a virtual image of a social object in a social application, and any virtual image is associated with at least one social operation control; determining, in response to an operation performed on the object screening control, at least one first target social object related to an online state of a current social user, where the online state of the current social user is configured for describing a state of a virtual image of the current social user or a state of the current social user; and collapsing the object screening control in the social application interface and displaying a virtual image of the at least one first target social object.

(3) Blockchain: it includes a series of blocks that are consecutive in a sequence of generation time. Once a new block is added to the blockchain, the new block is no longer removed. The block records recorded data submitted by a node in the blockchain system.

FIG. 12 is a schematic diagram of a block structure according to an embodiment of the present disclosure. Each block includes a hash value of a transaction record stored in the block (or a hash value of the block) and a hash value of a previous block. Blocks are connected by using hash values to form a blockchain. In addition, the block may further include information such as a timestamp when the block is generated. The blockchain is essentially a decentralized database, and is a string of data blocks generated through association by using a cryptographic method. Each data block includes related information, to verify validity (anti-counterfeiting) of information thereof and generate a next block.

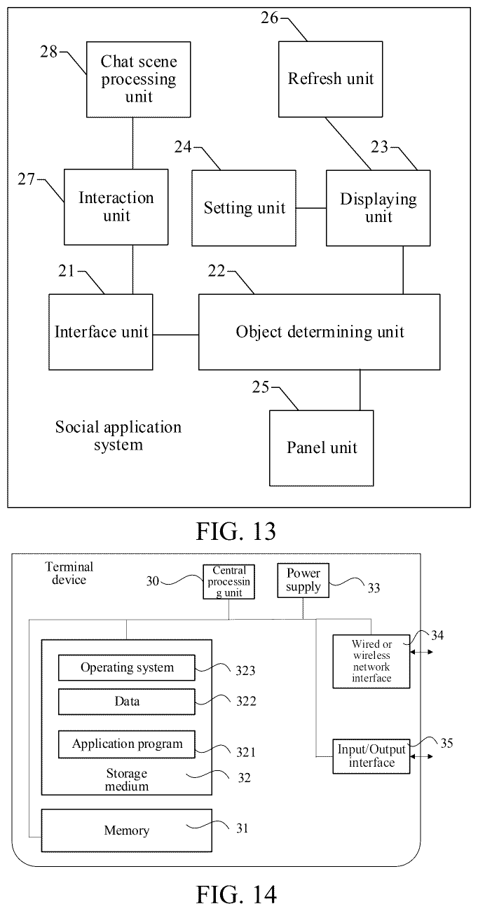

An embodiment of the present disclosure further provides a social application system. A schematic structural diagram of the social application system is shown in FIG. 13, and the social application system may specifically include:
an interface unit 21, configured to display a social application interface, where the social application interface includes an object screening control and a virtual image of a social object in a social application, and each virtual image is associated with at least one social operation control;
an object determining unit 22, configured to determine, in response to an operation performed on the object screening control displayed by the interface unit 21, at least one first social object related to an online state of a current social user from the social application, where the online state of the current social user is configured for describing a state of a virtual image of the current social user or a state of the current social user; and
the object determining unit 22 determines at least one first social object related to the online state of the current social user from the social application, and the online state of the current social user is configured for describing the state of the virtual image of the current social user or the state of the current social user; and
a displaying unit 23, configured to collapse the object screening control in the social application interface, and display a virtual image of the at least one first social object determined by the object determining unit 22.

The displaying unit 23 is specifically configured to display a two-dimensional image of the first social object, and load a three-dimensional model of the first social object based on the two-dimensional image of the first social object; and bind the three-dimensional model with a social operation control corresponding to the first social object, and perform a social interaction operation with the first social object when the social operation control receives a trigger operation.

In one embodiment of the present disclosure, the social object includes a social user, and the displaying unit 23 is further configured to display the online state of the current social user in a first area of the social application interface; and after the displaying of the online state in the first area has reached a preset time, replace the online state in the first area with a matching control, the matching control is configured to find, through matching based on a set condition, a social user to interact with the current social user from the social application.

Further, the displaying unit 23 is further configured to display at least one candidate online state in a second area of the social application interface, the first area and the second area are adjacent areas, and display a candidate online state in the first area when a user operation of moving from the first area to the second area is detected, or when a trigger operation performed on the second area is detected; and the object determining unit 22 is further configured to determine a related second social object based on the candidate online state, and then the displaying unit 23 is further configured to display a virtual image of the second social object in the social application interface.

In this case, the social application system in the embodiments of the present disclosure may further include: a setting unit 24, configured to replace, if the candidate online state displayed in the first area by the displaying unit 23 is not consistent with the online state of the current social user, the online state of the current social user with the candidate online state displayed in the first area.

In one embodiment of the present disclosure, the social application system further includes:

a panel unit 25, configured to jump to an object screening sub-control panel in response to the operation performed on the object screening control in the social application interface displayed by the interface unit 21, and display, on the object screening sub-control panel, object screening sub-controls respectively corresponding to a plurality of preset online states; and collapse the object screening sub-control panel in response to an operation performed on an object screening sub-control, and if an online state corresponding to the operated object screening sub-control is consistent with the online state of the current social user, perform the operation of determining the first social object by the object determining unit 22. Further, if the online state corresponding to the operated object screening sub-control is inconsistent with the online state of the current social user, the object determining unit 22 is instructed to determine a third social object related to the online state corresponding to the operated object screening sub-control, and the displaying unit 23 displays a virtual image of the third social object in the social application interface.

In some embodiments, the social object includes a social user, a topic, and a chat scene; and if the online state of the current social user is an interaction-type online state, the first social object related to the online state of the current social user includes at least one of the following: a social user having the same online state as the current social user, or a chat scene related to the online state of the current social user; and if the online state of the current social user is a content-type online state, the determined first social object related to the online state of the current social user includes at least one of the following: a social user having the same online state as the current social user, or a topic related to the online state of the current social user.

In some embodiments, the social application system further includes: a refresh unit 26, configured to: after the social application interface is displayed, where the social application interface includes a background space; when user operation information in the background space of the social application interface is detected, and the user operation information is a preset refresh operation gesture, obtain a fourth social object in response to the user operation information, and display a virtual image of the fourth social object in the social application interface by using the displaying unit 23.

Further, the setting unit 24 is further configured to: when the social application interface further includes a state setting control, jump to a state setting interface in response to an operation performed on the state setting control, where the state setting interface includes a state control; display an online state selecting interface in response to an operation performed on the state control, where the online state selecting interface includes at least one of the following: a plurality of candidate online states, an online-state automatic defining control, or an intelligently matched online state; and determine an online state determined in the online state selecting interface as the online state of the current social user.

An interaction unit 27 is configured to display a chat establishing control in response to an operation performed on the virtual image, where the social object displayed in the social application interface displayed by the interface unit 21 includes a social user, and the chat establishing control is configured to trigger real-time interaction with the social object corresponding to the virtual image; and create and display a first chat scene and an inviting control in response to an operation performed on the chat establishing control, and display, in the first chat scene, virtual images respectively corresponding to the current social user and a social object interacting with the current social user, where the inviting control is configured to invite at least one social object to join the first chat scene, and the at least one social object is in another chat scene or is not in any chat scene.

The interaction unit 27 is further configured to: when the social application interface further includes a matching control, after the social application interface is displayed, determine, in response to an operation performed on the matching control, a social object having the same online state as the current social user, and perform the operation of displaying the first chat scene.

Further, the social application system of this embodiment further includes:

a chat scene processing unit 28, configured to: before the interaction unit 27 displays the virtual image corresponding to the social object in the chat scene, create a second chat scene if a chat scene state of the current social user indicates that the current social user is not in the chat scene, and a chat scene state of the social object indicates that the social object is not in the chat scene; and add the current social user and the social object to the second chat scene, and establish a chat session to the social object; and if the chat scene state of the social object indicates that the social object is in the chat scene, and the chat scene state of the current social user indicates that the current social user is not in the chat scene, instruct the social object to exit the current chat scene; and create a third chat scene if the social object agrees to exit the current chat scene, add the current social user and the social object to the created third chat scene, and establish a chat session to the social object.

Further, the interaction unit 27 is further configured to pop up an invitation selecting control, where the invitation selecting control is configured to agree or refuse to join a chat scene of a social user performing invitation; and if a chat scene that the current social user is in is currently displayed, jump from the chat scene to the chat scene of the social user performing invitation when information about agreeing to join the chat scene of the social user performing invitation is received. In this way, the chat scene processing unit 28 is further configured to: when the interaction unit 27 receives the information about agreeing to join the chat scene of the social user performing invitation, if the chat scene state of the current social user indicates that the current social user is not in the chat scene, join the chat scene of the social user performing invitation; and if chat scene states of the current social user and the social user performing invitation indicate that the current social user and the social user performing invitation are in different chat scenes, the current social user exits a current chat scene, and joins the chat scene of the social user performing invitation.

In the social application system in this embodiment, the displayed social application interface includes the object screening control and the virtual image of each social object. In this way, through the operation performed on the object screening control, the object determining unit 22 determines the at least one first target social object related to the online state of the current social user, and the displaying unit 23 collapses the object screening control and display the virtual image of the at least one first target social object. The social application system determines the target social object based on the online state of the current social user. In this way, the current social user may dynamically set the online state, to define the determined target social object. This is convenient for the user to find a corresponding social object based on a requirement of the user, avoids a plurality of repeated matching operations required for matching a social object meeting the requirement of the user, and improves accuracy in a process of determining the target social object. In addition, the virtual image displayed in the social application interface is associated with the social operation control, so that it is convenient for the user to initiate a social operation on a specific social object by using the social operation control, to improve human-computer interaction efficiency in a social operation process of the user.

An embodiment of the present disclosure further provides a terminal device, and a schematic structural diagram of the terminal device is shown in FIG. 14. The terminal device may vary greatly due to different configuration or performance, and may include one or more central processing units (CPUs) 30 (for example, one or more processors), a memory 31, and one or more storage media 32 (for example, one or more mass storage devices) that stores an application program 321 or data 322. The memory 31 and the storage medium 32 may be transient or persistent storage devices. The program stored in the storage medium 32 may include one or more modules/units (not shown in the figure), and each module/unit may include a series of instructions and operations for the terminal device. Further, the CPU 30 may be configured to communicate with the storage medium 32, and perform, on the terminal device, the series of instructions and operations in the storage medium 32.

Specifically, the application program 321 stored in the storage medium 32 includes a social application program based on a virtual image, and the program may include the interface unit 21, the object determining unit 22, the displaying unit 23, the setting unit 24, the panel unit 25, the refresh unit 26, the interaction unit 27, and the chat scene processing unit 28 in the foregoing social application system. Details are not described herein again. Further, the CPU 30 may be configured to communicate with the storage medium 32, and perform, on the terminal device, the series of operations that correspond to the social application program based on a virtual image and that is stored in the storage medium 32.

The terminal device may further include one or more power supplies 33, one or more wired or wireless network interfaces 34, one or more input/output interfaces 35, and/or one or more operating systems 323, for example, Windows Server™, Mac OS X™, Unix™, ™ or FreeBSD™.

The operations performed by the social application system in the foregoing method embodiments may be based on the structure of the terminal device shown in FIG. 14.

Another aspect of the embodiments of the present disclosure further provides a computer-readable storage medium. The computer-readable storage medium stores a plurality of computer programs, and the computer programs are configured to be loaded by a processor to perform the method for social networking based on a virtual image performed by the foregoing social application terminal or social application system.

Another aspect of the embodiments of the present disclosure further provides a terminal device, including a processor and a memory.

The memory is configured to store a plurality of computer programs, and the computer programs are configured to be loaded by the processor to perform the method for social networking based on a virtual image performed by the social application system. The processor is configured to implement each of the plurality of computer programs.

In addition, according to an aspect of the present disclosure, a computer program product or a computer program is provided. The computer program product or the computer program includes computer instructions, and the computer instructions are stored in a computer-readable storage medium. A processor of the computer device reads the computer instructions from the computer-readable storage medium, and the processor executes the computer instructions, so that the computer device performs the method for social networking based on a virtual image provided in the foregoing various implementations.

A person of ordinary skill in the art may understand that all or some of the steps of the methods in the embodiments may be implemented by a program instructing relevant hardware. The program may be stored in a computer-readable storage medium. The storage medium may include: a read-only memory (ROM), a random access memory (RAM), a magnetic disk, an optical disc, or the like.

The foregoing describes the method for social networking based on a virtual image, the system, the storage medium, and terminal device provided in the embodiments of the present disclosure in detail. Specific examples are used in the specification to illustrate the principles and implementations of the present disclosure. The descriptions of the embodiments are merely for helping understand the method and the core idea thereof in the present disclosure. In addition, for a person of ordinary skill in the art may, based on the idea of the present disclosure, make modifications with respect to the specific implementations and the application scope. Therefore, the content of this specification shall not be construed as a limitation to the present disclosure.

What is claimed is:

1. A method for social networking based on a virtual image, executed by a terminal device, and comprising:
displaying a social application interface, the social application interface comprising an object screening control and virtual images of a plurality of social objects in a social application, the social application on the terminal device being logged in by a current social user, and each virtual image being associated with at least one social operation control;
determining, in response to an operation performed on the object screening control, at least one first social object related to an online state of the current social user from the social application, the online state of the current social user describing a state of a virtual image of the current social user or a state of the current social user; and
collapsing the object screening control in the social application interface and displaying a virtual image of the at least one first social object.

2. The method according to claim 1, wherein the social object comprises a social user, and the method further comprises:
displaying the online state of the current social user in a first area of the social application interface; and
after the displaying of the online state in the first area has reached a preset time, replacing the online state in the first area with a matching control, the matching control being configured to find, based on a set condition, a social user to interact with the current social user from the social application.

3. The method according to claim 2, wherein at least one candidate online state is displayed in a second area of the social application interface, the first area and the second area being adjacent areas, the method further comprises:
displaying a candidate online state in the first area upon detecting a user operation of moving from the first area to the second area or a trigger operation performed on the second area; and
the method further comprises:
determining a related second social object based on the displayed at least one candidate online state; and
displaying a virtual image of the second social object in the social application interface.

4. The method according to claim 3, further comprising:
in response to that the candidate online state displayed in the first area is not consistent with the online state of the current social user, replacing the online state of the current social user with the candidate online state displayed in the first area.

5. The method according to claim 1, wherein the collapsing the object screening control in the social application interface and displaying a virtual image of the at least one first social object comprises one of the following:
collapsing the virtual image of the current social user and the object screening control in the social application interface and displaying the virtual image of the at least one first social object;
collapsing the object screening control in the social application interface and displaying the virtual image of the current social user and the virtual image of the at least one first social object; or
collapsing the object screening control in the social application interface and displaying a virtual image of the at least one first social object.

6. The method according to claim 1, wherein in response to the operation performed on the object screening control, the method further comprises:
jumping to an object screening sub-control panel in response to the operation performed on the object screening control, and displaying, on the object screening sub-control panel, object screening sub-controls respectively corresponding to a plurality of online states; and
collapsing the object screening sub-control panel in response to an operation performed on an object screening sub-control, and in response to that an online state corresponding to the operated object screening sub-control is consistent with the online state of the current social user, performing the operation of determining the first social object; or in response to that the online state corresponding to the operated object screening sub-control is inconsistent with the online state of the current social user, determining a third social object related to the online state corresponding to the operated object screening sub-control, and displaying a virtual image of the third social object in the social application interface.

7. The method according to claim 1, wherein the social object comprises a social user, a topic, and a chat scene;
in response to that the online state of the current social user is an interaction-type online state, the first social object related to the online state of the current social user comprises at least one of the following: a social user having the same online state as the current social user, or a chat scene related to the online state of the current social user; and
in response to that the online state of the current social user is a content-type online state, the first social object related to the online state of the current social user comprises at least one of the following: a social user having the same online state as the current social user, or a topic related to the online state of the current social user.

8. The method according to claim 1, wherein the displaying a virtual image of the at least one first social object comprises:
displaying a two-dimensional image of the first social object, and loading a three-dimensional model of the first social object based on the two-dimensional image of the first social object; and
binding the three-dimensional model with a social operation control corresponding to the first social object, and performing a social interaction operation with the first social object when the social operation control receives a trigger operation.

9. The method according to claim 1, wherein after the displaying a social application interface, the social application interface comprises a background space, and the method further comprises:
when user operation information is received in the background space of the social application interface and the user operation information is a preset refresh operation gesture, obtaining a fourth social object based on the user operation information, and displaying a virtual image of the fourth social object on the social application interface.

10. The method according to claim 1, wherein the social application interface further comprises a state setting control, and the method further comprises:
jumping to a state setting interface in response to an operation performed on the state setting control, the state setting interface comprising a state control;
displaying an online state selecting interface in response to an operation performed on the state control, the online state selecting interface comprising at least one of the following: a plurality of candidate online states, an online-state automatic defining control, or an intelligently matched online state; and
determining an online state determined in the online state selecting interface as the online state of the current social user.

11. The method according to claim 1, wherein the social object comprises a social user, and the method further comprises:
displaying a chat establishing control in response to an operation for the virtual image, the chat establishing control being configured to trigger real-time interaction with a social object corresponding to the virtual image; and
creating and displaying a first chat scene and an inviting control in response to an operation for the chat establishing control, and displaying the virtual image corresponding to the current social user and a virtual image corresponding to a social object to interact with the current social user in the first chat scene, the inviting control being configured to invite at least one social object to join the first chat scene.

12. The method according to claim 11, wherein the social application interface further comprises a matching control, and after displaying of the social application interface, the method further comprises:
determining, in response to an operation for the matching control, a social object having the same online state as the current social user, and performing the operation of displaying the first chat scene.

13. The method according to claim 11, before displaying a virtual image corresponding to a social object in the chat scene, further comprising:
creating a second chat scene in response to that a chat scene state of the current social user indicates that the current social user is not in the chat scene and a chat scene state of the social object indicates that the social object is not in the chat scene; adding the current social user and the social object to the second chat scene, and establishing a chat session to the social object; and
in response to that the chat scene state of the social object indicates that the current social user is in the chat scene and the chat scene state of the current social user indicates that the social object is not in the chat scene, instructing the social object to exit the current chat scene, and in response to that the social object agrees to exit the current chat scene, creating a third chat scene, adding the current social user and the social object to the created third chat scene, and establishing a chat session to the current social user.

14. The method according to claim 1, further comprising:
popping up an invitation selecting control, the invitation selecting control is configured to agree to or refuse to join a chat scene of a social user performing invitation; and
in response to that a chat scene that the current social user is in is currently displayed, jumping from the chat scene to the chat scene of the social user performing invitation when information about agreeing to join the chat scene of the social user performing invitation is received.

15. The method according to claim 14, wherein when information about agreeing to join the chat scene of the social user performing invitation is received, the method further comprises:
adding the current social user to the chat scene of the social user performing invitation in response to that the chat scene state indicates that the current social user is not in the chat scene; and
in response to that chat scene states of the current social user and the social user performing invitation indicate that the current social user and the social user performing invitation are in different chat scenes, exiting, by the current social user, a current chat scene, and joining the chat scene of the social user performing invitation.

16. A non-transitory computer-readable storage medium, having a plurality of computer programs stored therein, the computer programs being configured to be loaded by a processor to perform:
displaying a social application interface, the social application interface comprising an object screening control and virtual images of a plurality of social objects in a social application, the social application being logged in by a current social user, and each virtual image being associated with at least one social operation control;
determining, in response to an operation performed on the object screening control, at least one first social object related to an online state of the current social user from the social application, the online state of the current social user describing a state of a virtual image of the current social user or a state of the current social user; and
collapsing the object screening control in the social application interface and displaying a virtual image of the at least one first social object.

17. The storage medium according to claim 16, wherein the social object comprises a social user, and the computer programs further cause the processor to perform:
displaying the online state of the current social user in a first area of the social application interface; and
after the displaying of the online state in the first area has reached a preset time, replacing the online state in the first area with a matching control, the matching control being configured to find, based on a set condition, a social user to interact with the current social user from the social application.

18. The storage medium according to claim 17, wherein at least one candidate online state is displayed in a second area of the social application interface, the first area and the second area being adjacent areas, and the computer programs further cause the processor to perform:
displaying a candidate online state in the first area upon detecting a user operation of moving from the first area to the second area or a trigger operation performed on the second area; and
the method further comprises:
determining a related second social object based on the displayed at least one candidate online state; and
displaying a virtual image of the second social object in the social application interface.

19. The storage medium according to claim 18, wherein the computer programs further cause the processor to perform:
in response to that the candidate online state displayed in the first area is not consistent with the online state of the current social user, replacing the online state of the current social user with the candidate online state displayed in the first area.

20. A terminal device, comprising a processor and a memory,
the memory being configured to store a plurality of computer programs, and the computer programs being configured to be loaded by the processor to perform:
displaying a social application interface, the social application interface comprising an object screening control and virtual images of a plurality of social objects in a social application, the social application on the terminal device being logged in by a current social user, and each virtual image being associated with at least one social operation control;
determining, in response to an operation performed on the object screening control, at least one first social object related to an online state of the current social user from the social application, the online state of the current social user describing a state of a virtual image of the current social user or a state of the current social user; and
collapsing the object screening control in the social application interface and displaying a virtual image of the at least one first social object.
